(19) United States
(12) Patent Application Publication
(10) Pub. No.: US 2013/0064592 A1
(43) Pub. Date: Mar. 14, 2013

(54) PRINTING ENGINE MODULE

(71) Applicants: Wei Lun Chen, New Taipei City (TW); Sheng Chia Chen, New Taipei City (TW)

(72) Inventors: Wei Lun Chen, New Taipei City (TW); Sheng Chia Chen, New Taipei City (TW)

(73) Assignee: TSC AUTO ID TECHNOLOGY CO., LTD., TAIPEI CITY (TW)

(21) Appl. No.: 13/366,421

(22) Filed: Feb. 6, 2012

(30) Foreign Application Priority Data
Sep. 14, 2011 (TW) 100217166

(51) Int. Cl. B41J 33/16

(52) U.S. Cl. 400/227

(57) ABSTRACT

A printing engine module includes at least a base, a printing assembly, a carbon ribbon reel, a carbon ribbon collection shaft, a power transmission device, and a plurality of transmission elements. The base couples to corresponding mounting portions of a chassis of a host device of barcode printer. The printing assembly, the carbon ribbon reel, and the carbon ribbon collection shaft are mounted to a base side. The carbon ribbon reel and the carbon ribbon collection shaft supply and collect a carbon ribbon for the printing assembly. The power transmission device and the transmission elements are mounted to an opposite side of the base supply power to the carbon ribbon collection shaft and the printing assembly for rotating a carbon ribbon and a printing label. The printing engine module is receivable and coupleable in the host device of barcode printer.

### BACKGROUND OF THE INVENTION

1. Field of the Invention

The present invention relates to a printing engine module, and in particular to a structure of printing engine module that is applicable to a host of barcode printer by being incorporated in an enclosure of the barcode printer host to carry out supply and collection of carbon ribbon and label printing operation.

2. The Related Arts

Barcode printers have been commonly used in applications where printing of barcodes is needed. The conventional barcode printer must provide various forms of enclosure of label printing assembly to handle various types of label. Particularly, the barcode printer has a core portion that is composed of a printing assembly, a carbon ribbon reel, and a power mechanism. This requires great expenses of molding and manufacturing of the conventional barcode printer, and consequently, the manufacturing costs of the barcode printer cannot be properly reduced, making it economically disadvantageous for the industry.

Further, any breakdown or damage of the printing assembly, the carbon ribbon reel, and the power mechanism of the conventional barcode printer requires the breakdown or damaged component to be removed from the enclosure of the barcode printer, which often takes a great effort, for replacement or maintenance operation. This makes the maintenance and repairing of the barcode printer difficult and increases the maintenance and repairing costs of the barcode printer, both being adverse to the maintenance of barcode printers.

Prior art references are known, such as Taiwan Utility Model No. M395585, which relates to a printing device with marking function, in which a typical structure of barcode printer is illustrated with the printing assembly, the carbon ribbon reel, and the power mechanism all being arranged in a fixed manner inside an enclosure of the barcode printer. Similar problems of manufacturing cost and maintenance cost being high are present as those discussed previously in respect of the conventional barcode printer. And, also, part replacement and maintenance are difficult.

Furthermore, Chinese Patent No. CN101400521, which relates to a printer with module block, and US Patent Publication No. 2008/0101838, which relates to a ribbon module structure of label printer, respectively disclose a label printer having a financial module block and a reel module of a label printer. Both references teach a module of a portion of the barcode printer and these references do not suggest any solution for reducing manufacturing and assembling cost and maintenance expense of a barcode printer in respect of the core components of printing assembly, carbon ribbon reel, and power mechanism of the barcode printer and also suffer the problems of being hard to replace and maintain parts.

### SUMMARY OF THE INVENTION

The conventional label printer suffers the problems an drawbacks that core components of printing assembly, carbon ribbon reel, and power mechanism cannot be readily assemble and maintain, which leads to increased expenses for assembling and maintenance, and also making it difficult to replace parts for maintenance purposes.

Thus, the primary objective of the present invention is to provide a printing engine module, which comprises at least a base, a printing assembly, a carbon ribbon reel, a carbon ribbon collection shaft, a power transmission device, and a plurality of transmission elements, wherein the base has a peripheral portion forming a plurality of connection sections for coupling to corresponding mounting portions of a chassis of a host device of barcode printer. The printing assembly, the carbon ribbon reel, and the carbon ribbon collection shaft are mounted to one side of the base. The carbon ribbon reel and the carbon ribbon collection shaft function to supply and collect a carbon ribbon for the printing assembly. The power transmission device and the plurality of transmission elements are mounted to an opposite side of the base. The power transmission device and the transmission elements are coupled to each other and the transmission elements are also connected to the carbon ribbon collection shaft and the printing assembly, whereby the power transmission device and the transmission elements supply power to the carbon ribbon collection shaft and the printing assembly for rotating a carbon ribbon and a printing label. As such, a module that is receivable and coupleable in a host device of barcode and can supply and collect a carbon ribbon and carry out printing of label is formed.

The effectiveness of the printing engine module according to the present invention is that core components including a base, a printing assembly, a carbon ribbon reel, a carbon ribbon collection shaft, a power transmission device, and transmission elements are integrated as a printing engine module for a label printer. The base is provided with connection sections, which allows of coupling, in a modular form, to an enclosure of a host device of barcode printer host device so as to realize applications to enclosures of various models of barcode printer host device to reduce the expense of manufacturing. Further, in case of any breakdown or damage of any one of the printing assembly, the carbon ribbon reel, the carbon ribbon collection shaft, the power transmission device and the transmission elements, simple replacement can be done on the printing engine module to thereby reduce the cost and labor required for maintenance of the barcode printer, making the replacement and maintenance of components of the barcode printers simplified.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view showing a printing engine module constructed in accordance with a first embodiment of the present invention;

FIG. 2 is a perspective view showing the printing engine module of FIG. 1 coupled to threaded mounting holes formed in a chassis of a host device of the barcode printer;

FIG. 3 is an exploded view of FIG. 2;

FIG. 4 is a perspective view illustrating spatial relationship of connection between a power transmission device and transmission elements and a carbon ribbon collection shaft of the printing engine module according to the present invention;

FIG. 5 is a perspective view illustrating an example of application of the printing engine module according to the present invention;

FIG. 6 is a perspective view illustrating coupling of the printing engine module of FIG. 5 to the host device of the barcode printer;

FIG. 7 is a perspective view showing a printing engine module constructed in accordance with a second embodiment of the present invention;

FIG. 8 is an exploded view of FIG. 7;

FIG. 9 is a perspective view showing a printing engine module constructed in accordance with a third embodiment of the present invention; and

FIG. 10 is a perspective view showing a printing engine module constructed in accordance with a fourth embodiment of the present invention.

### DETAILED DESCRIPTION OF THE PREFERRED EMBODIMENTS

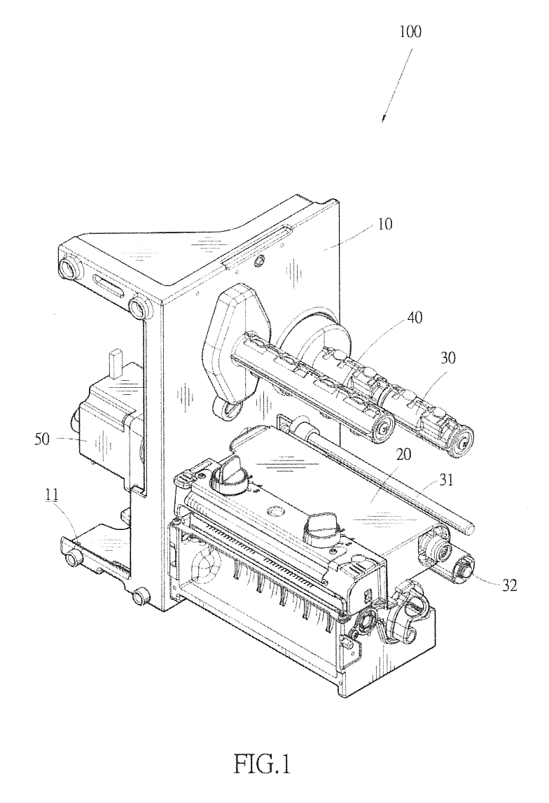

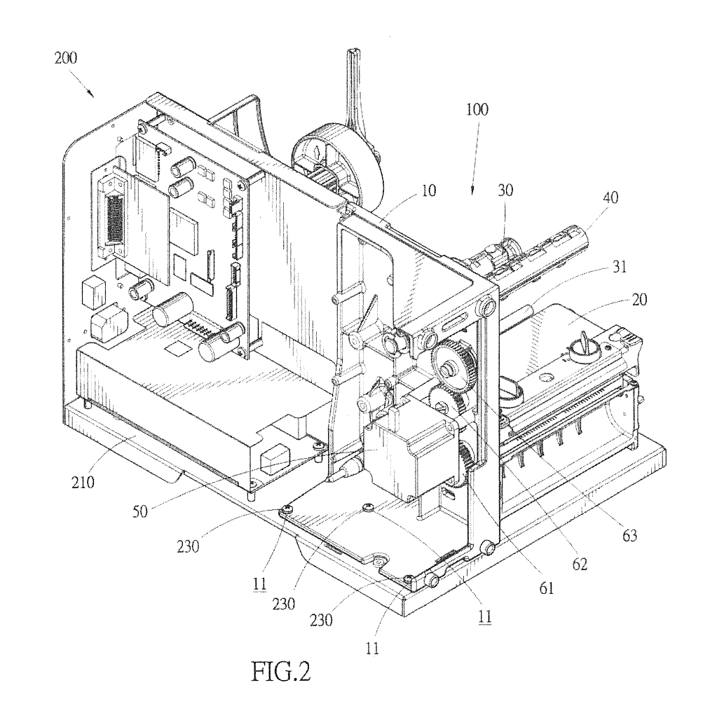

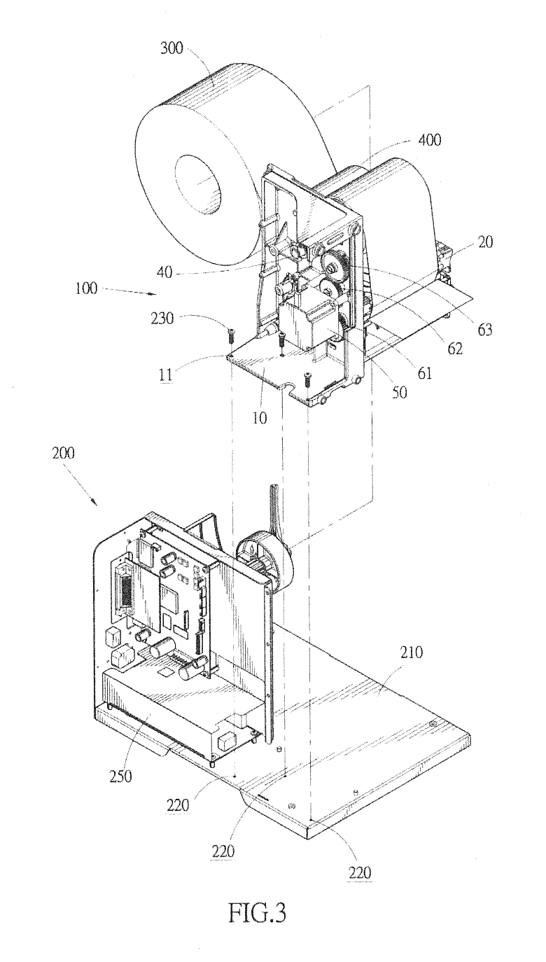

With reference to the drawings and in particular to FIGS. 1-4, a printing engine module constructed in accordance with a first embodiment of the present invention is generally shown at 100. The printing engine module 100 comprises at least one base 10, which has a peripheral portion forming a plurality of connection sections 11. The connection sections 11 are not limited in respect of the locations and types thereof and in the present invention, threaded holes formed in a bottom of the base 10 are taken as an example for illustration. The connection sections 11 are alignable with respect to threaded mounting holes 220 formed in a chassis 210 of a host device 200 of a barcode printer so as to be secured together with bolts 230. The combination between the connection sections 11 of the base 10 and the threaded mounting holes 220 of the chassis 210 of the barcode printer host device 200 is not limited to being realized through bolts 230 and any structure provides equivalent results are considered within the scope of the present invention.

At least one printing assembly 20, a carbon ribbon reel 30, a carbon ribbon collection shaft 40 are mounted at one side of the base 10. The printing assembly 20 receives a barcode label paper roll 300 to extend therethrough and perform printing. The carbon ribbon reel 30 and the carbon ribbon collection shaft 40 are respectively coupled to opposite ends of a carbon ribbon roll 400, functioning to supply and collect a carbon ribbon with which the printing operation of the printing assembly 20 is performed. The carbon ribbon collection shaft 40 has an end forming at least one engagement element 41, which is not limited to any specific type and is illustrated in the form of a gear as an illustrative example. Arranged below the carbon ribbon reel 30 are a carbon ribbon hold-down axle 31 and a paper roller 32.

At least one power transmission device 50 and a plurality of transmission elements 61, 62, 63 are coupled to an opposite side of the base 10. The power transmission device 50 is not limited to any specific type and a servo motor is taken as an example for illustration. The power transmission device 50 is coupled to the transmission element 61, the transmission element 61 mates the transmission element 62, and the transmission element 62 mates the transmission element 63, so that the power transmission device 50 and the transmission elements 61, 62, 63 are combined together as an inter-linked power transmission assembly. The transmission elements 61, 62, 63 are illustrated in the form of gears as an example for illustration, but other mechanical parts, such as a combination of rubber roller or pulley based belt assembly, which provides the same result of operation are considered within the scope of the present invention.

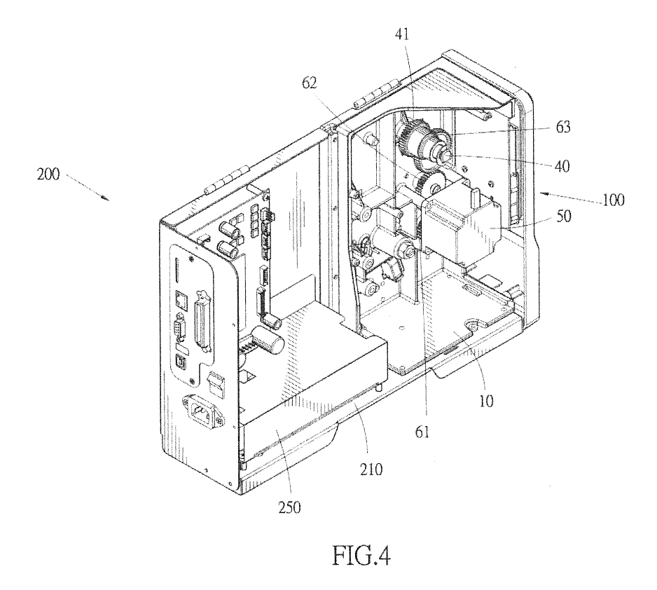

The transmission element 61 is coupled to the printing assembly 20 through a rotation element to supply a power for the printing assembly 20 to rotate the barcode label paper roll 300. The transmission element 63 is in mating engagement with the engagement element 41 of the carbon ribbon collection shaft 40 (as shown in FIG. 4) to supply a power for rotating the carbon ribbon roll 400.

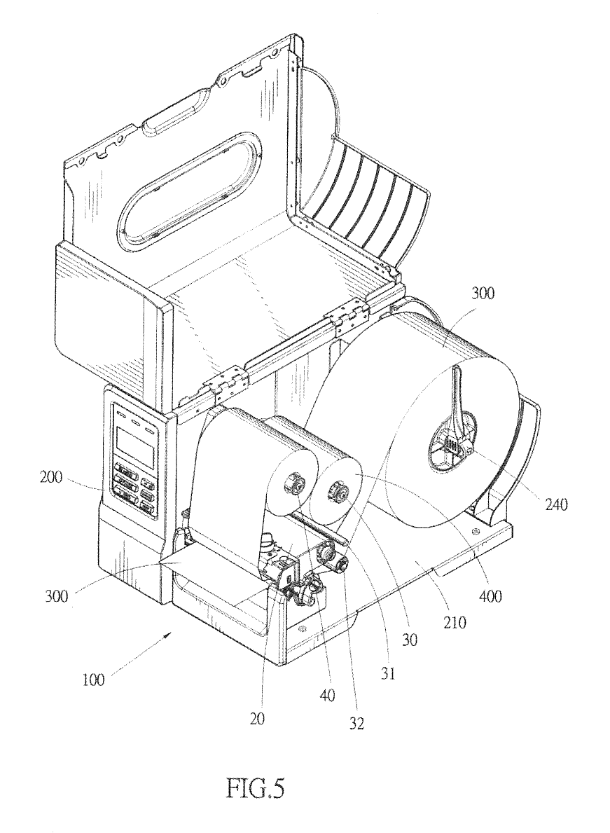

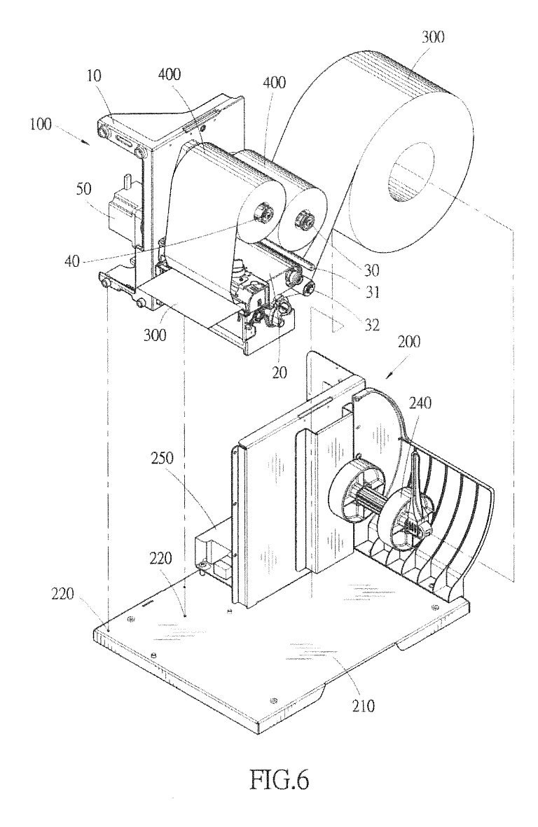

Also referring to FIGS. 5 and 6, an example of application of the printing engine module 100 according to the present invention is illustrated, wherein the printing engine module 100 is shown connected to the threaded mounting holes 220 of the chassis 210 of the barcode printer host device 200 through the connection sections 11 and the bolts 230 so as to couple the printing engine module 100 and the barcode printer host device 200 together. The barcode label paper roll 300 is mounted to a paper roll mounting axle 240 located inside the barcode printer host device 200. The barcode label paper roll 300 has an end extending under the paper roller 32 and further extending into the printing assembly 20. The carbon ribbon roll 400 is mounted to the carbon ribbon reel 30. The carbon ribbon roll 400 has an end extending under the carbon ribbon hold-down axle 31 and further extending into the printing assembly 20 to then project outside the printing assembly 20 for coupling to the carbon ribbon collection shaft 40. The barcode printer host device 200 comprises a control circuit module 250, which is electrically connected to the printing assembly 20 and the power transmission device 50 of the printing engine module 100 in order to control the operations of the printing assembly 20 and the power transmission device 50 for having the printing assembly 20 carrying out a printing operation on the barcode label paper roll 300 and having the carbon ribbon reel 30 and the carbon ribbon collection shaft 40 respectively supplying the carbon ribbon from the carbon ribbon roll 400 to the printing assembly 20 and collecting the carbon ribbon used.

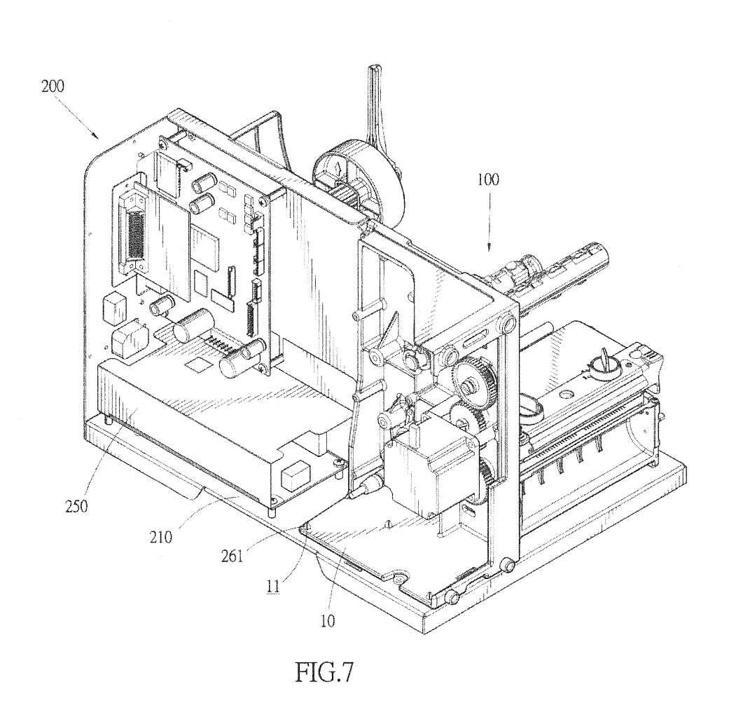

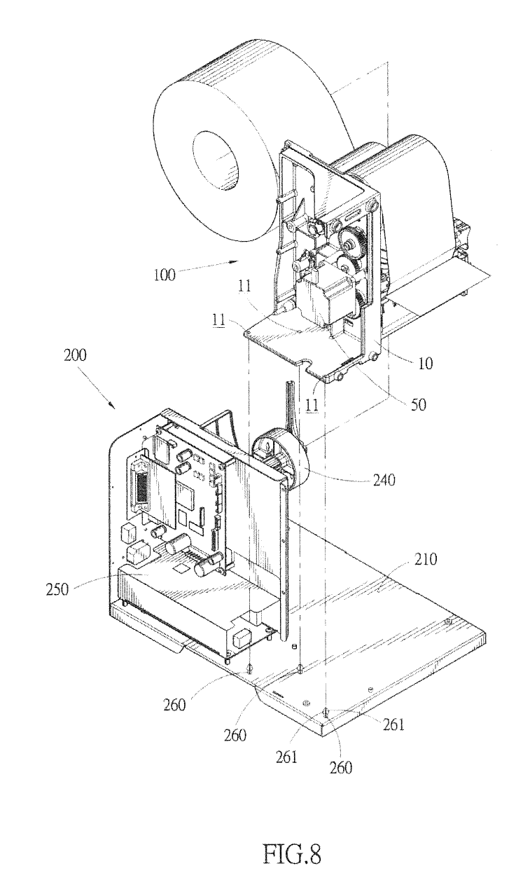

Referring to FIGS. 7 and 8, a printing engine module constructed in accordance with a second embodiment of the present invention is shown and designated at 100, wherein the connection sections 11 of the base 10 are shown in the form of through holes. The chassis 210 of the barcode printer host device 200 comprises a plurality of resilient pegs 260, each of which has an end that is cut and forms a plurality of resilient locking blocks 261. The resilient locking blocks 261 show resiliency for shape restoration after being compressed, so that the connection sections 11 of the base 10 are respectively fit over the resilient pegs 260 of the chassis 210 of the barcode printer host device 200, whereby the resilient locking blocks 261, after passing through the connection sections 11, may assume locking engagement with the connection sections 11 (as shown in FIG. 7) due to the restoring resiliency so as to secure the printing engine module 100 to the chassis 210 of the barcode printer host device 200.

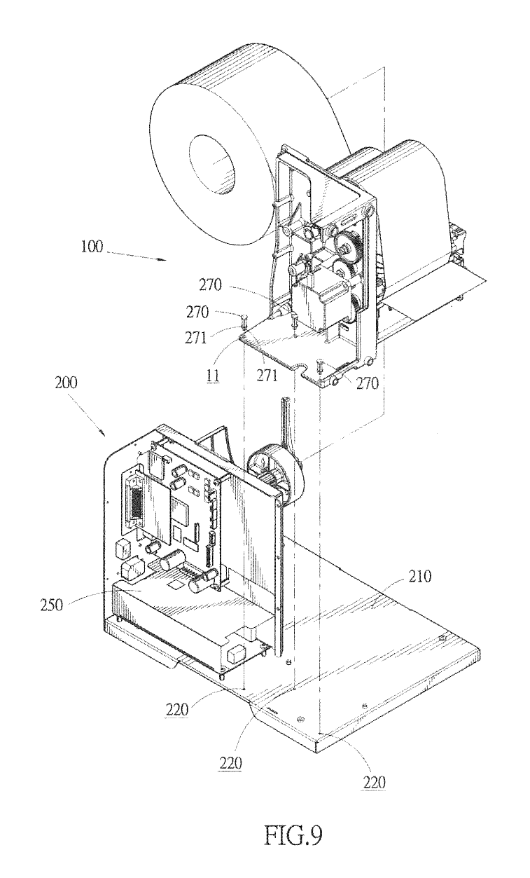

Referring to FIG. 9, a printing engine module constructed in accordance with a third embodiment of the present invention is shown and designated at 100, wherein the connection sections 11 of the base 10 are shown in the form of through holes. The connection sections 11 are set corresponding in position to the threaded mounting holes 220 of the chassis 210 of the barcode printer host device 200 to respectively receive a plurality of resilient coupling pins 270 to fit therethrough for coupling. Each of the resilient coupling pins 270 has an end that is cut to form a plurality of resilient coupling blocks 271. The resilient coupling blocks 271 show resiliency for shape restoration after being compressed, so that the resilient coupling blocks 271, after passing through the connection sections 11, may further fit into the threaded mounting holes 220 of the chassis 210 of the barcode printer host device 200 to secure the printing engine module 100 to the chassis 210 of the barcode printer host device 200.

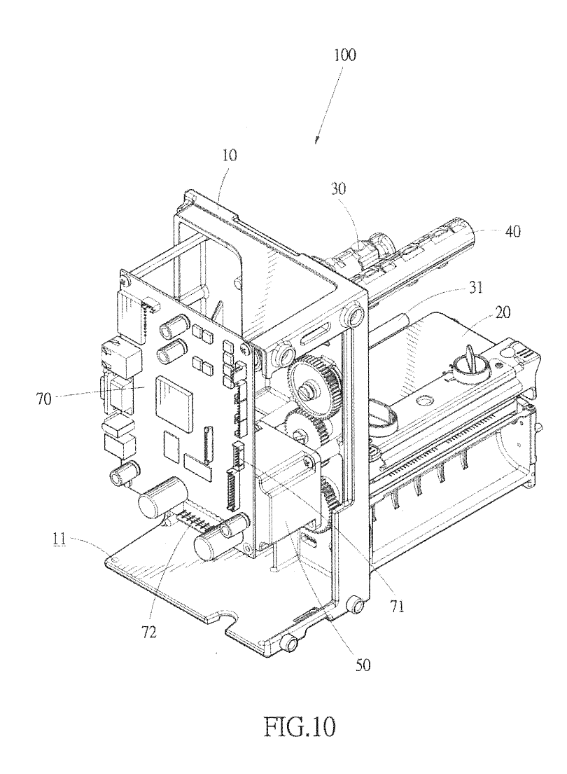

Referring to FIG. 10, a printing engine module constructed in accordance with a fourth embodiment of the present invention is shown and designated at 100, wherein a control circuit board 70 is shown mounted to one side of the base 10. The control circuit board 70 is electrically connected to the printing assembly 20 and the power transmission device 50 to control the operations of the printing assembly 20 and the power transmission device 50. The control circuit board 70 comprises at least one external control interface connection port 71 and an external power supply port 72 to allow the printing engine module 100, after being coupled to the chassis 210 of the barcode printer host device 200, to be connected to the control circuit module 250 of the barcode printer host device 200 or a remote control interface and a power supply of the barcode printer host device 200 or an external power supply, so that the printing engine module 100 according to the present invention can be accommodated and connected to barcode printer host devices 200 of various controls and power supplies.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A printing engine module, comprising:
at least one base, which has a peripheral portion forming a plurality of connection sections for coupling to a chassis of a barcode printer host device;
at least one printing assembly, which is mounted ton one side of the base to carry out a barcode label printing operation on a barcode label paper roll of the barcode printer host device;
at least one carbon ribbon reel and a carbon ribbon collection shaft, which are mounted to the one side of the base, the carbon ribbon reel and the carbon ribbon collection shaft being respectively coupled to opposite ends of a carbon ribbon roll, functioning to supply and collect a carbon ribbon with which the printing operation of the printing assembly is carried out; and
at least one power transmission device and a plurality of transmission elements, which are mounted to an opposite side of the base, the power transmission device and the transmission elements being operatively coupled together to form an inter-linked assembly, the transmission elements being connected to the carbon ribbon collection shaft and the printing assembly, so that the power transmission device and the transmission elements supply power to the carbon ribbon collection shaft for winding the carbon ribbon and supply power to the printing assembly for rotating the barcode label paper roll.

2. The printing engine module as claimed in claim 1, wherein the connection sections of the base comprise threaded holes to respectively receive bolts for coupling to the chassis of the barcode printer host device.

3. The printing engine module as claimed in claim 1, wherein the connection sections of the base comprises through holes to respectively receive resilient coupling pins therethrough for coupling to the chassis of the barcode printer host device.

4. The printing engine module as claimed in claim 3, wherein the connection sections of the base comprise through holes for respectively receiving therethrough the resilient coupling pins of which each has an end that is cut to form a plurality of resilient coupling blocks.

5. The printing engine module as claimed in claim 1, wherein a carbon ribbon hold-down axle and a paper roller are arranged below the carbon ribbon reel.

6. The printing engine module as claimed in claim 1, wherein the carbon ribbon collection shaft has an end forming an engagement element.

7. The printing engine module as claimed in claim 6, wherein the engagement element comprises a gear.

8. The printing engine module as claimed in claim 1, wherein the power transmission device comprises a servo motor.

9. The printing engine module as claimed in claim 1, wherein the transmission elements comprise gears.

10. The printing engine module as claimed in claim 1, wherein a control circuit board is mounted to one side of the base and is electrically connected to the printing assembly and the power transmission device.

11. The printing engine module as claimed in claim 10, wherein the control circuit board comprises at least one external control interface connection port and an external power supply port.
